(19) United States
(12) Patent Application Publication
(10) Pub. No.: US 2005/0010904 A1
(43) Pub. Date: Jan. 13, 2005

(54) Information recording device, method for the same, program for the same and recording medium storing the program

(76) Inventor: Ryuichiro Morioka, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/878,496

(22) Filed: Jun. 29, 2004

(30) Foreign Application Priority Data
Jun. 30, 2003 (JP) 2003-187219

(51) Int. Cl. G06F 13/12

(52) U.S. Cl. 717/120; 710/74

(57) ABSTRACT

When start of data recording is set, a CPU (153) establishes an internal connection according to the necessity and makes a contents sending device (120) fetched prespecified data, and the data is transmitted to and recorded in a HD device (130) via a data bus (110). An free space in the HD device (130) is detected during the operation for recording data, and when it is recognized that the free space has dropped to a prespecified value or below, the other data having been recorded in the HD device (130) is transferred to a contents recording device (140) via the data bus (110) to secure a required free space in the HD device (130). With the configuration, data can be recorded smoothly and without fail according to a situation of data recording.

### BACKGROUND OF THE INVENTION

1.FIELD OF THE INVENTION

The present invention relates to an information recording device for recording data in any of a plurality of recording sections, a method for the same, a program for the same, and a recording medium storing the program recorded.

2. DESCRIPTION OF RELATED ART

As a recording device for recording therein data such as video data or voice data, there has been known a device comprising a plurality of recording sections in which data is transferred between the recording sections according to the size of an free space enabling data storage therein in each of the recording sections (Refer to, for instance, Japanese Patent Laid-Open Publication No. 2002-152642, page 4, right column to page 6, right column).

In the device disclosed in this publication, a CPU in a control section detects an free space in a first recording medium and an free space in a second recording medium from a memory space managing section for a first recording device as well as from a memory space managing section for a second recording device, and detects a quantity of reserved image information required for reserved picture recording based on contents of the reserved picture recording set in response to an input operation by a user in an operating section. When the quantity of reserved image information is larger than an free space in the first recording medium, a quantity of insufficient memory space for the reserved image information is computed by subtracting the free space in the first recording medium from a memory space required for the reserved image information. Then, image information with a quantity of image information larger than the quantity of insufficient memory space for the reserved image information is selected from image information having been recorded in the first recording medium, and the image information is transferred to the second recording medium to secure an free space for recording the reserved image information without dividing it.

With the device described in the publication described above, however, image information is transferred depending on contents of reserved picture recording set in response to an input operation by a user, and therefore, when the recording time is prolonged during picture recording, or when an image signal system for the image data is switched and the quantity of image information increases, sometimes a required free space can not be fetched, which may disable the reserved picture recording.

### SUMMARY OF THE INVENTION

An object of the present invention is to provide an information recording device capable of ensuring an free space in response to situations during data recording, a method for the same, a program for the same, and a recording medium storing the program recorded.

An information recording device according to an aspect of the present invention includes: a data fetching section for fetching data; a first recording section capable of recording the fetched data therein; an internal state detecting section for detecting, during the operation for recording the data in the first recording section, an free space for recording the data; a second recording section capable of recording therein data having been recorded in the first recording section; and a control section for transferring the data having been recorded in the first recording section to the second recording section for recording the data therein when it is recognized that the detected free space is a prespecified value or below.

An information recording device according to another aspect of the present invention includes: a data fetching section for fetching data; a plurality of recording sections capable of recording the fetched data therein; an internal state detecting section for detecting an free space for recording therein the data in the recording section; and a control section for having the fetched data recorded in any of the plurality of recording sections and transferring the data having been recorded in this recording section to other recording section when the control section recognized that an free space in the recording section for the data to be recorded therein is a prespecified value or below, in which the control section recognizes a decrease state of the free space in the recording section with the data recorded therein, and makes the internal state detecting section detect an free space in the recording section for the data to be recorded therein at a timing corresponding to the decrease state of the free space.

An information recording device for recording input data in any of a plurality of recording sections according to still another aspect of the present invention includes: a control section for having the input data recorded in any of the plurality of recording sections and transferring the data having been recorded in the recording section to other recording section when an free space in the recording section with the data recorded therein is a prespecified value or below.

An information recording method for recording fetched data in any of a plurality of recording sections according to further aspect of the present invention includes the steps of: recording the fetched data in any of the plurality of recording sections and also detecting an free space allowing for storage of data therein in the recording section with the data having been recorded therein; and transferring, when it is recognized that the detected free space is a prespecified value or below, the data having been recorded in the recording section with the data having been recorded therein to any recording section other than the recording section with the data having been recorded therein.

An information recording method for recording fetched data in any of a plurality of recording sections according to still further aspect of the present invention includes the steps of: recognizing a decrease state of an free space in the recording section for the fetched data to be recorded therein; detecting an free space in the recording section for the data to be recorded therein at a timing corresponding to the decrease state of this free space; and transferring the data having been recorded in the recording section for the data to be recorded therein to other recording section when it is recognized that the detected free space is a prespecified value or below.

An information recording method for recording input data in any of a plurality of recording sections according to still further aspect of the present invention includes the steps of: having the input data recorded in any of the plurality of recording sections; and transferring the data having been recorded in the recording section to other recording section when it is recognized that an free space in the recording section with the data recorded therein is a prespecified value or below.

An information recording program according to still further aspect of the present invention executes the above-described information recording method by a computer.

A recording medium according to still further aspect of the present invention stores the above-described information recording program in a manner readable by a computer.

### BRIEF DESCRIPTION OF THE DRAWINGS

FIG. 1 is a block diagram showing general configuration of an information processing device according to a first embodiment of the present invention;

FIG. 2 is a flowchart showing operations for recording data in the first embodiment;

FIG. 3 is a block diagram illustrating the state in which data is recorded in a HD device in the first embodiment;

FIG. 4 is a block diagram illustrating the state in which the data is recorded and transferred in the first embodiment;

FIG. 5 is a block diagram showing general configuration of an information processing device according to a second embodiment of the present invention;

FIG. 6 is a flowchart showing operation for recording data in the second embodiment;

FIG. 7 is a block diagram showing general configuration of an information processing device according to a third embodiment of the present invention;

FIG. 8 is a block diagram showing general configuration of an image processing device according to a fourth embodiment of the present invention;

FIG. 9 is a block diagram showing general configuration of an image processing device according to a fifth embodiment of the present invention; and

FIG. 10 is a block diagram showing general configuration of an information processing device according to a sixth embodiment of the present invention.

### DETAILED DESCRIPTION OF PREFERRED EMBODIMENT(S)

Information recording devices according to embodiments of the present invention are described below with reference to the related drawings. Description of the embodiments of the present invention below assume the configuration for recording video data and voice data, but the present invention is not limited to this configuration, and the present invention can be applied to the configuration for storing various types of data such as image data, program, and application software.

[First Embodiment]

(Configuration of Information Recording Device)

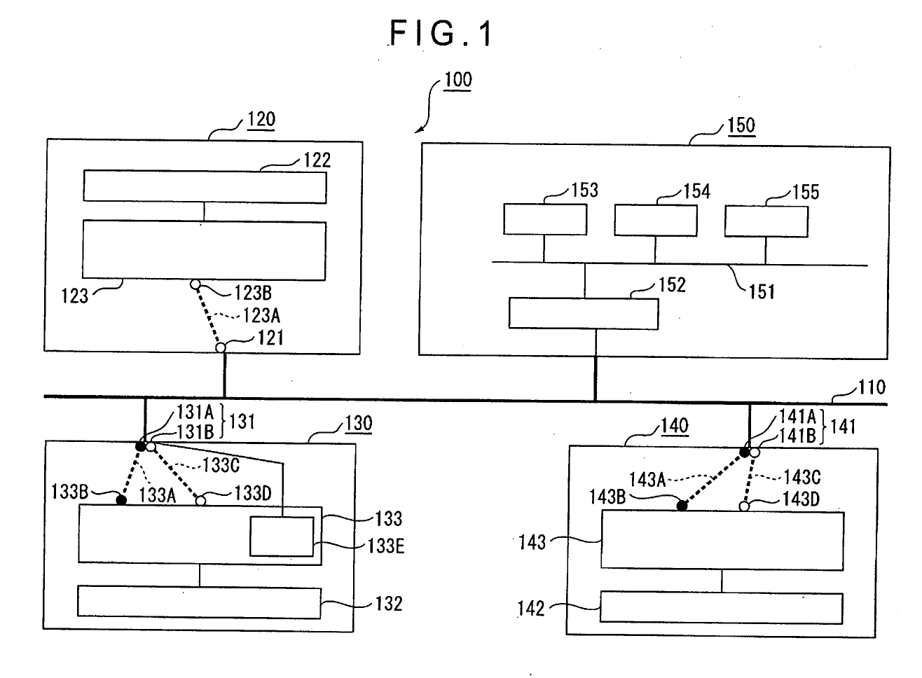

FIG. 1 is a block diagram showing general configuration of an information recording device according to a first embodiment of the present invention. In FIG. 1, the reference numeral 100 indicates an information recording device, and this information recording device 100 is a device for recording therein information such as, for instance, video data or voice data, namely a device for recording pictures. This information recording device 100 includes a data bus 110, a contents sending device 120, a HD (Hard Disk) device 130 as a first recording section, a contents recording device 140 as a second recording section, and a network controller 150.

The data bus 110 is an electronic network through which information based on, for instance, the IEEE 1394 standard can be transacted. Connected to this data bus 110 are the contents sending device 120, the HD device 130, the contents recording device 140, and the network controller 150 respectively.

The contents sending device 120 fetches data by means of various methods, and sends the fetched data to the data bus 110. This contents sending device 120 includes a device output plug 121, a data fetching section 122 as a data fetching means, and a contents sending section 123.

The device output plug 121 is, for instance, a device plug as a logical concept, and is detachably connected to the data bus 110 so that various types of data can be transmitted from the contents sending device 120 via the data bus 110.

The data fetching section 122 fetches data from LANs (Local Area Network) such as the Intranet, Extranet, Ethernet (registered as a trademark) based on a general purpose protocol like the TCP/IP (Transmission Control Protocol/Internet Protocol), or from other types of networks such as a communication line network or a broadcasting network including a plurality of base stations each capable of transmitting and receiving information through a radio medium, and further sometimes directly receives information with a radio medium such like a tuner. As the radio medium, any medium of electric waves, light, sonic waves, and electromagnetic waves can be used for this purpose.

The contents sending section 123 is connected to the data fetching section 122, and outputs the data fetched by the data fetching section 122 to the data bus 110. This contents sending section 123 can also check the internal state such as a state of the fetched data, for specific examples, a transfer rate of the data to be fetched by the data fetching section 122, a header, contents of the data itself such as a data rate or a data type, and also such information as time for starting data decoding. The data sending section 123 has an output plug 123B connected via a sending device internal connection 123A as a logical concept to the device output plug 121. It is to be noted that the fetched data concerning the internal state can be read out via the data bus 110 by the network controller 150 from the contents sending section 123.

The HD device 130 records data sent from the contents sending device 120 therein according to the necessity, and also transfers the recorded data according to the necessity. This HD device 130 includes a first device plug 131, a HDD main body 132, and a HDD subunit 133.

The first device plug 131 is, for instance, a device plug which is a logical concept, and includes a first device input plug 131A and a first device output plug 131B. The first device input plug 131 A receives data transmitted via the data bus 110. The first device output plug 131B transmits various data from the HD device 130 to the data bus 110.

The HDD main body 132 includes a HD as a recording medium not shown, and a HDD (Hard Disk Drive) not shown for recording data in this HD and also reading out the recorded data. This HDD main body 132 is connected to the HDD subunit 133. The HDD main body 132 is controlled by the HDD subunit 133, records data outputted from the HDD subunit 133 in the HD with the HDD, and reads out the data recorded in the HD with the HDD to output the data recorded in the HD to the HDD subunit 133.

The HDD subunit 133 controls operations of the HDD main body 132 for recording and reading data. This HDD subunit 133 includes a logical HD input plug 133B connected via the logical first HDD internal connection 133A to the first device input plug 131A, and a logical HD output plug 133D connected via a logical second HDD internal connection 133C to the first device output plug 131B. The HDD subunit 133 receives the data received by the first device input plug 131 A from the data bus 110 with the HD input plug 133B via the logical first HDD internal connection 133A and outputs the data to the HDD main body 132 according to the necessity while the HDD subunit 133 sends the data from the HD output plug 133D via the logical second HDD internal connection 133C and the first device output plug 131B to the data bus 110.

The HDD subunit 133 has an internal state detecting section 133E as an internal state detecting means for detecting an internal state of the HD device 130. This internal state detecting section 133E executes operations for detecting the internal state, such as, for instance, detecting an free space enabling storage of data therein by controlling the HDD main body 132, or recognizing how the free space has decreased by detecting a recording rate per unit time by means of detecting various types of signals passing through the data bus 110 type by type. This internal state detecting section 133E outputs the detected internal state via the internal connection as a logical concept to the data bus 110, and the outputted internal state can be read by the network controller 150.

The contents recording device 140 fetches the data transferred from the HD device 130, records the data according to the necessity, and further outputs the recorded data according to the necessity. This contents recording device 140 includes a second device plug 141, a recording main body 142, and a contents subunit 143.

The second device plug 141 is, for instance, a device plug which is a logical concept, and has a second device input plug 141A and a second device output plug 141B. The second device input plug 141A receives the data transferred via the data bus 110 from the HD device 130. The second device output plug 141B sends out various data from the contents recording device 140.

The recording main body 142 includes a drive or a driver not shown for recording data in a recording medium not shown such as, for instance, an optical disk or a magnetic optical disk, a magnetic disk, or a memory, and also for reading out the data recorded in the recording medium. This recording main body 142 is connected to the contents subunit 143. The recording main body 142 is controlled by the contents subunit 143, and records the data outputted from the contents subunit 143 in a recording medium with the drive, and reads out the data having been recorded in the recording medium with a drive, and outputs the data to the contents subunit 143.

The contents subunit 143 controls operations in the recording main body 142 for recording and reading data. This contents subunit 143 includes a logical recording input plug 143B connected to a second device input plug 141A via a logical first recording internal connection 143A, and a logical recording output plug 143D connected to a second device output plug 141B via a logical second recording internal connection 143C. The contents subunit 143 receives the data received by the second device input plug 141A from the data bus 110 in the recording input plug 143B via the logical first recording internal connection 143A, outputs the data to the recording main body 142 according to the necessity, and also sends out the data from the recording output plug 143D via the logical second recording internal connection 143C and the second device output plug 141B to the data bus 110. Further, the contents subunit 143 can executes the operations for detecting the internal state such as, for instance, detecting an free space enabling storage of data therein to be recorded in the recording main body 142 or checking decrease of the free space. Namely, a second internal state detecting section not shown is provided in the contents subunit 143. The detected data concerning the internal state can be read out via the data bus 110 by the network controller 150.

The network controller 150 controls operations of the entire information recording device 100, and has the data fetched from the outside recorded. Namely, the network controller 150 controls operations of the contents sending device 120, the HD device 130 and the contents recording device 140 each connected to the data bus 110, and also checks how the data is recorded. This network controller 150 includes an internal bus 151, an interface 152, a central processing unit (CPU) 153 as a control section, and further, for instance, a memory 154 as a storage section, and an input section 155.

The internal bus 151 is a bus through which various types of signals can pass. Connected to this internal bus 151 are the interface 152, the CPU 153, the memory 154, and the input section 155.

The interface 152 is connected to the data bus 110, and can access the data based on, for instance, the IEEE 1394 standard in the data bus 110, namely can execute the preset input interface processing for the data inputted from the data bus 110 and based on the IEEE 1394 standard, and sends out the data as processed signals to the internal bus 151. Also the interface 152 executes the present output interface processing in response to input of a processed signal from the internal bus 151, and sends the signal as data based on the IEEE 1394 standard to the data bus 110.

The CPU 153 is connected to the contents sending device 120, the HD device 130, and the contents recording device 140 each connected via the interface 152 to the data bus 110, and controls operations of the contents sending device 120, the HD device 130, and the contents recording device 140. More specifically, the CPU 153 provides controls to establish respective logical internal connections according to the necessity, to make the contents sending device 120 fetch data to be recorded and send out the fetched data, to make the HD device 130 fetch the data to be recorded, to record and transfer data, and to make the contents recording device 140 record therein or output the transferred data. Further, the CPU 153 fetches data concerning the internal state such as the recording state in each contents sending device 120, the HD device 130, and the contents recording device 140. More specifically, as described above, the CPU 153 fetches data concerning the internal state recognized by the contents sending section 123, internal state detecting section 133E of the HDD subunit 133, and contents subunit 143 respectively.

The memory 154 temporally stores data when the CPU 153 executes various types of processing. This memory 154, for instance, stores and reads out various types of information to be processed by the CPU 153 under controls by the CPU 153.

The input section 155 has various types of buttons and knobs (not shown) for operations. The input section 155 outputs a prespecified signal in response to an input operation with any of the various buttons and knobs to the internal bus 151. Contents of the processing executed by the CPU 153 is set according to the signal from this input section 155. For instance, conditions for recording data are set for data to be fetched in selection of tuning a prespecified command button provided on a display screen of a web browser, or for a point of time and a period of time to start recording data, and also which of the HD device 130 and the contents recording device 140 is to be selected for recording data. As this input section 155, the configuration is allowable in which a signal is outputted in response to an input operation via a radio medium such as a remote controller, the signal is received by a receiving section connected to the internal bus 151, and the CPU 153 sets the conditions according to the signal.

(Operations of Information Recording Device)

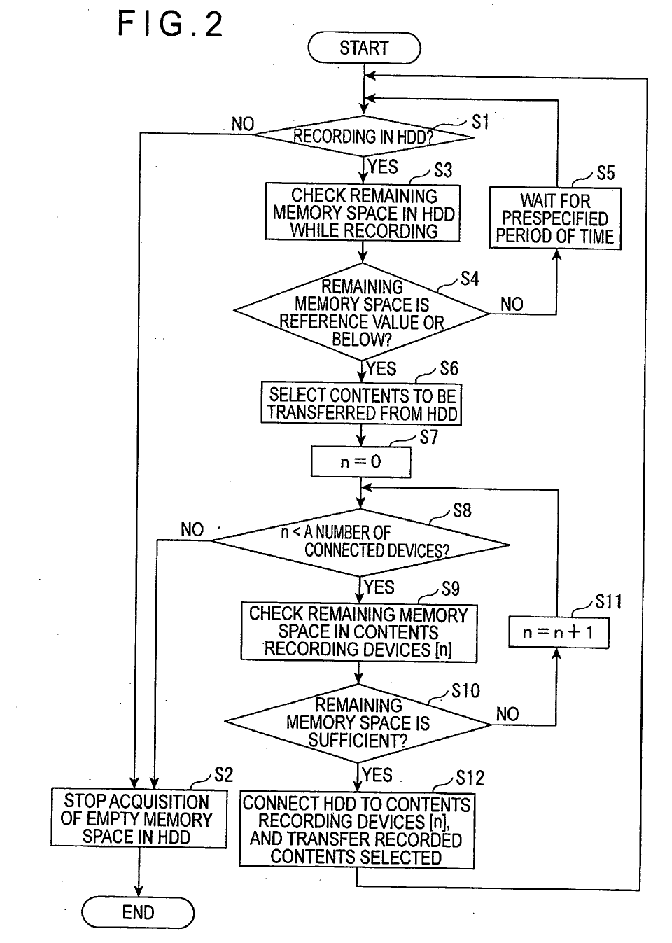

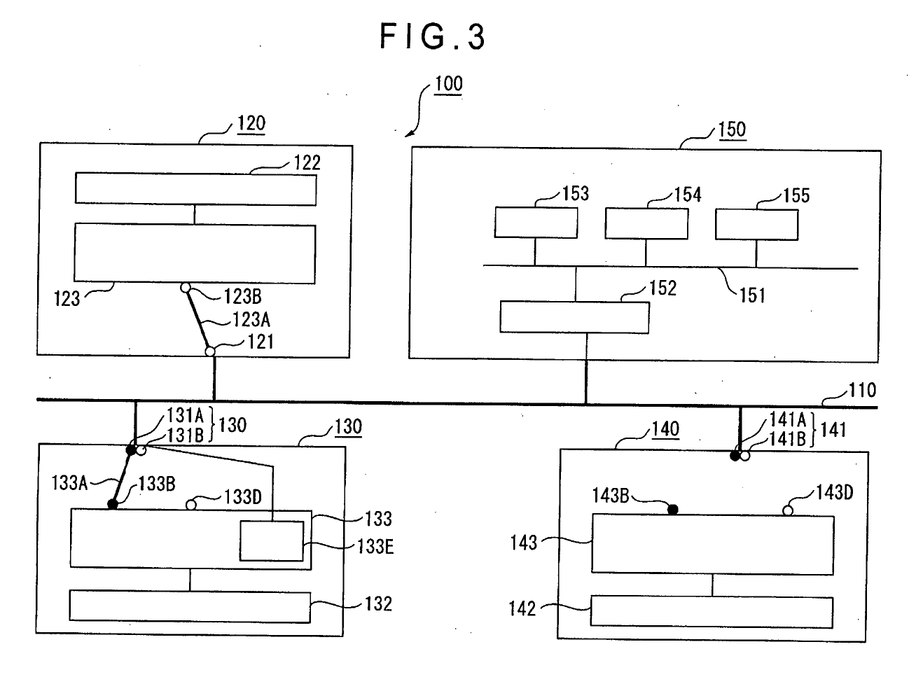

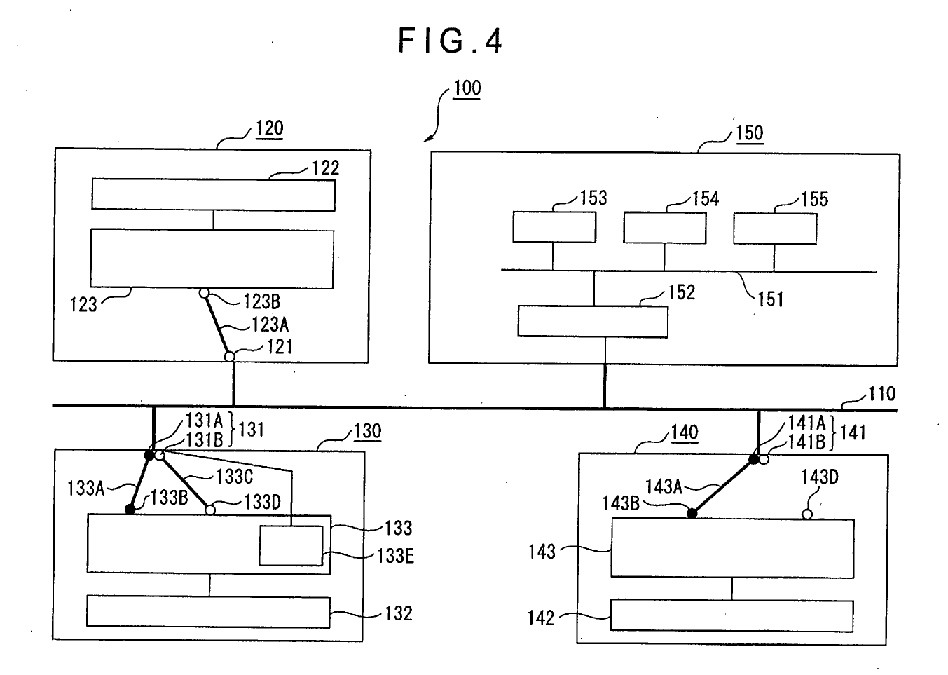

Next, operations of the information recording device 100 for picture recording are described with reference to the related drawings. FIG. 2 is a flowchart showing a sequence of operations for picture recording. FIG. 3 is a block diagram illustrating the state in which data is recorded in the HD device 130. FIG. 4 is a block diagram illustrating the state in which the data is being recorded in the HD device 130 and simultaneously transferred to the contents recording device 140.

At first, a user starts power supply by turning ON a power supply unit not shown. When the power supply is started, the CPU 153 in the network controller 150 executes polling, namely checks various types of devices connected to the data bus 110. For instance, the CPU 153 recognizes that the contents sending device 120, the HD device 130, and the contents recording device 140 are connected to the data bus 110. Then the CPU 153 has a number of unit of the devices connected to the data bus 110 stored in the memory 154.

Then the user carries out input operations with the input section 155 of the network controller 150 according to the necessity for setting conditions for picture recording by fetching necessary data. Namely, in response to a prespecified input operation by the user with the input section 155, conditions for selecting data to be recorded or those for recording data are set in the CPU 153. Then the CPU 153 makes the data fetching section 122 select data to be recorded by controlling the contents sending device 120 via the interface 152. Then the user recognizes the selected data as voices or images provided from, for instance, a voice-generating section like a speaker or an output device such as a display unit, and performs a prespecified input operation with the input section 155 to instruct start of picture recording so that the CPU 153 sets the conditions for picture recording. In response to this setting step, the CPU 153 starts picture recording which corresponds to the processing for recording data shown in the flowchart in FIG. 2.

Namely, at first the CPU 153 controls the contents sending device 120, makes the data fetching section 122 fetch the data, and sequentially outputs the data to the contents sending section 123. Then the CPU 153 makes the contents sending section 123 process the data according to the necessity, namely convert the data to signals based on, for instance, the IEEE 1394 standard. Further, as shown in FIG. 3, the CPU 153 establishes the logical sending device internal connection 123A in the contents sending device 120 to have the output plug 123B connected to the device output plug 121, and further establishes the logical first HDD internal connection 133B in the HD device 130 to have the logical HD input plug 133B connected to the first device input plug 131A so that the contents sending device 120 and the HD device 130 are mutually connected for data transaction. When the connection is established, the data fetched and converted by the contents sending device 120 is sequentially transferred via the data bus 110 to the HD device 130, and is sequentially recorded in the HD by the HDD subunit 133.

The CPU 153 then determines whether the data is being recorded in the HD device 130 or not, namely whether a signal for termination of data recording has been recognized or not (step S1). As the signal for termination of data recording, there are, for instance, a signal corresponding to an input operation by the user for instructing termination of picture recording in the input section 155, a signal indicating that the final data to be fetched in the contents sending device 120 has been fetched and fetching of data to be recorded has been completed, a signal indicating end of operations for recording data in the HD device 130, and further a signal indicating that the clock information counted in the CPU 153 has reached a preset point of time for termination of picture recording.

In this step S1, when the CPU 153 receives a signal for termination of data recording, the CPU 153 terminates the processing for ensuring an free space, namely a memory space for recording data in the HD device 130 (step S2) and terminates the processing for recording the data. Namely, the CPU 153 terminates the processing for picture recording by releasing the contents sending device 120, the HD device 130, the sending device internal connection 123A in the contents recording device 140, the HDD internal connections 133A, 133C, and the recording-internal connections 143A, 143C for stopping operation of each component. Also the configuration is allowable in which, when a signal for termination of data recording is recognized in step S1, the operation for picture recording is immediately stopped without shifting to step S2, or in which the picture recording is carried out to a limit of a memory space of the HD device 130 and the operation for picture recording is terminated at the limit of the memory space.

In step S1, in a case where the CPU 153 does not recognize a signal for termination of data recording during the process of recording data in the HD device 130, the CPU 153 recognizes a remaining free space enabling storage of data therein from the data in the HD device 130 previously recognized when power supply is started (step S3). More specifically, the CPU 153 fetches the information concerning the internal state detected by the internal state detecting section 133E in the HDD subunit 133 of the HD device 130 via the data bus 110. By fetching information concerning an free space included in this internal state information, the CPU 153 recognizes an free space. It is to be noted that the information concerning this empty space is stored in the memory 154 according to the necessity.

The CPU 153 determines whether the free space in the HD device recognized in step S3 is not more than a prespecified reference value or below previously set and stored in the memory 154 or not (step S4). When it is recognized that the free space in the HD is not less than the reference value, namely that there is still a sufficient memory space, the CPU 153 again returns to step S1 to continue the processing for picture recording after the prespecified period of time has passed, for instance, after counting clocks with the CPU 153 for a prespecified period of time (step S5).

On the other hand, in step S4, when the CPU 153 recognizes that the free space in the HD is the preset reference value or below, The CPU 153 fetches information concerning the internal state from the internal state detecting section 133E of the HDD subunit 133, namely a data rate or information concerning the time for picture recording already stored in the HD. Then the CPU 153 selects data to be transferred based on the information fetched from the HDD subunit 133 (step S6). In this step of data selection, for instance, data more than the preset data rate is selected based on information concerning the time for picture recording inputted in the input section 155 or the information concerning the data recognized in the contents sending section 123. Then, the CPU 153 executes setting to indicate that a number of “n” indicating a number of units having been subjected to the processing for an free space is “0”, namely sets the “n=0” (step S7), and stores the data in the memory 154. Herein the “n” indicating the number of units having been subjected to the processing for an free space indicates a number of devices excluding, for instance, the HD device 130 in which data can be recorded, namely a number of connected contents recording devices 140. It is to be noted that the “n” may indicate a number of all connected devices.

Then the CPU 153 determines whether the number “n” for the recording devices having been subjected to the processing for checking whether an free space is the number of connected devices or above recognized when power supply was started or not (step S8). In this step S8, when the CPU 153 recognizes that the number “n” for the recording devices having been subjected to the processing for checking an free space is more than the number of connected devices recognized, namely that the processing for securing an free space in the all connected contents recording devices 140 capable of recording the data has been finished, the CPU 153 goes to step S2, and terminates the processing for picture recording.

On the other hand, in step S8, when the CPU 153 recognizes that the number “n” for the recording devices having been subjected to the processing for checking an free space is the number of connected devices or less, the CPU 153 checks an free space in the contents recording devices 140 enabling storage of picture data therein (step S9). More specifically, the CPU 153 fetches the information concerning the internal state detected by the contents subunit 143 in the contents recording device 140 via the data bus 110. By fetching the information concerning an free space included in the information concerning the internal state, the CPU 153 recognizes an free space of a recording medium in the contents recording device 140. This information concerning an free space is stored in the memory 154 according to the necessity.

Then the CPU 153 determines whether an free space in the recording medium of the contents recording device 140 is sufficient or not (step S10). The determination as to an free space in this step S10 is carried out by checking, for instance, whether the remaining free space is equal to or more than the free space for recording data therein selected in step S6 or not, or whether the remaining free space is the preset specified value or above stored in the memory 154 or not. In this step S10, when the CPU 153 determines that the free space in the contents recording device 140 determined in this step is not sufficient, the CPU 153 executes the processing for adding “1” to the number “n” for the recording devices to be checked as to an free space in a recording medium thereof, namely set “n” to “n+1” (step S11). The number “n” for the recording devices to be checked for an free space respectively set in this step S11 is stored in the memory 154 according to the necessity. Then the CPU 153 returns to step S8, and repeats the processing for sequentially checking an free space in each of the recording media of the contents recording devices 140 connected thereto.

On the other hand, in the step S10, when the CPU 153 determines that the free space in the recording medium of the contents recording device 140 is sufficient, the CPU 153 executes the processing for transferring the data selected in step S5 and already having been stored in the HD device 130 to the contents recording device 140 (step S12).

Namely, as shown in FIG. 4, the CPU 153 connects the HD output plug 133D of the HDD subunit 133 in the HD device 130 to the first output plug 131B with the logical second HDD internal connection 133C. Further the CPU 153 connects the recording input plug 143B of the contents subunit 143 in the contents recording device 140 to the second device input plug 141A with the logical recording internal connection 143A so that the data can be transferred between the HD device 130 and the contents recording device 140. Then the CPU 153 makes the HDD subunit 133 transmit the data selected in step S6 and already having been stored in the HD to the data bus 110, and also executes the processing for fetching the data transmitted by the contents subunit 143 to the data bus 110 and recording the data in the recording medium. It is to be noted that, during the process of transferring the data in this step S10, data fetching and transmitting in the contents sending device 120 and data recording in the HD device 130 are continuously executed.

In this step S12, when the CPU 153 recognizes that data transfer has been completed, the CPU 153 again returns to step S1 to continue the processing for picture recording. The CPU 153 can recognize completion of data transfer, for instance, by fetching the information concerning the internal state from the internal state detecting section 133E of the HD device 130 once for every prespecified period of time to recognize that all of the data to be transferred has been transmitted, or by fetching information concerning the internal state from the contents subunit 143 in the contents recording device 140 to recognize that all of the data to be transferred has been recorded. Returning to step S1 may not be always executed after all of the data has been transmitted, and the processing for returning to step S1 may be executed after the processing for transferring data is started, or after it is recognized that a certain amount of data has been transmitted.

When recording of picture data has been completed and it is necessary to output the recorded data with the output section, namely when it is necessary to replay the recorded picture, since the CPU 153 sets the processing for replaying the picture in response to a prespecified input operation by the user in the input section 155, the CPU 153 fetches the information concerning the internal state from the HD device 130 and the contents recording device 140 respectively to recognize the device in which the data to be replayed has been recorded. Then the CPU 153 establishes internal connection for the device in which the data to be replayed has been recorded to output the data to the data bus 110, and then transmits the data to the output section for replaying the recorded picture data.

More specifically, when the data recoded in the HD device 130 is to be replayed, the CPU 153 establishes the logical second HDD internal connection 133C, connects the logical HD output plug 133D of the HDD subunit 133 to the first device output plug 131B, and transmits the data recorded in the HD to the data bus 110. Further when the data recorded in the contents recording device 140 is to be replayed, the CPU 153 establishes the logical second recording internal connection 143C, connects the logical recording output plug 143D of the contents subunit 143 to the second device output plug 141B, and transmits the data recorded in the recording medium to the data bus 110.

(Advantages in First Embodiment)

As described above, in the first embodiment described above, the data fetched by the data fetching section 122 of the contents sending device 120 is transmitted to the HD device 130 under the controls by the CPU 153 of the network controller 150 to be recorded in the HDD main body 132, and during the operations for recording data, checking is concurrently executed to check whether the empty space memory of the HD in the HDD main body 132 detected by the internal state detecting section 133E of the HDD subunit 133 has dropped to a prespecified value or below or not. When it is determined that the free space has dropped to the prespecified value or below, other data having been recording to this HDD main body 132 is transferred to the contents recording section 140 to be recorded therein.

Because of this configuration, even in a case where, for instance, a signal type of data changes to that requiring a higher data rate during picture recording and an free space previously acquired becomes insufficient for executing picture recording continuously as experienced in the configuration in which an free space is previously acquired according to a volume of data to be recorded, since the data having been recorded is transferred according to the necessity in response to a remaining free space changing according to a state of data recording in the HD to ensure a necessary free space according to the present embodiment, picture recording can be executed according to a state of data recording smoothly and without fail. Since a set of data is divided to a plurality of groups to be recorded in different recording devices respectively like dividing a set of data to a group to be recording in the HD device 130 and that to be recorded in the contents recording device 140, or dividing a set of data to be transferred to a plurality of groups to be recorded in different contents recording devices 140 respectively, a set of data is recorded without being divided, so that data management is not complicated, and the processing for reading out data for replay or the like can easily be carried with the processing efficiency improved.

When it is recognized that an empty space in the HD has dropped to a prespecified value or below, an free space in the contents recording device 140 is checked to ascertain that the recognized free space is a prespecified value or above, the data already having been recorded in the HD is transferred to the contents recording device 140. Because of this configuration, it is possible to acquire an free space in response to a state of data recording and to ensure the configuration for recording data smoothly and without fail.

In a case where a plurality of contents recording devices 140 are connected, free spaces in the contents recording devices 140 are sequentially checked, and data is transferred to any one of the contents recording devices 140 having an free space of a prespecified value or above. Because of this configuration, it is not necessary to check free spaces in all of the contents recording devices 140, and the processing efficiency can easily be improved.

Transaction and transfer of data to be recorded are carried out through the data bus 110 which the information based on the IEEE 1394 standard can pass. Because of this feature, a device capable of executing data recording and data transfer concurrently such as the HD device 130 can be used. Therefore, data recording can be carried out more efficiently as compared to that carried out with a device requiring switching of operating mode between the data recording mode and the data transfer mode, and further a buffer for temporally storing fetched data during data transfer or the like is not required, which allows for more simplified configuration.

Data recording is stopped when there is no free space of a prespecified value or above allowing for data transfer in the contents recording device 140. Because of this configuration, such operations as execution of data recording operations under the possibility of interruption of data fetching and data recording can be prevented, and waste of consumed power can be prevented.

[Second Embodiment]

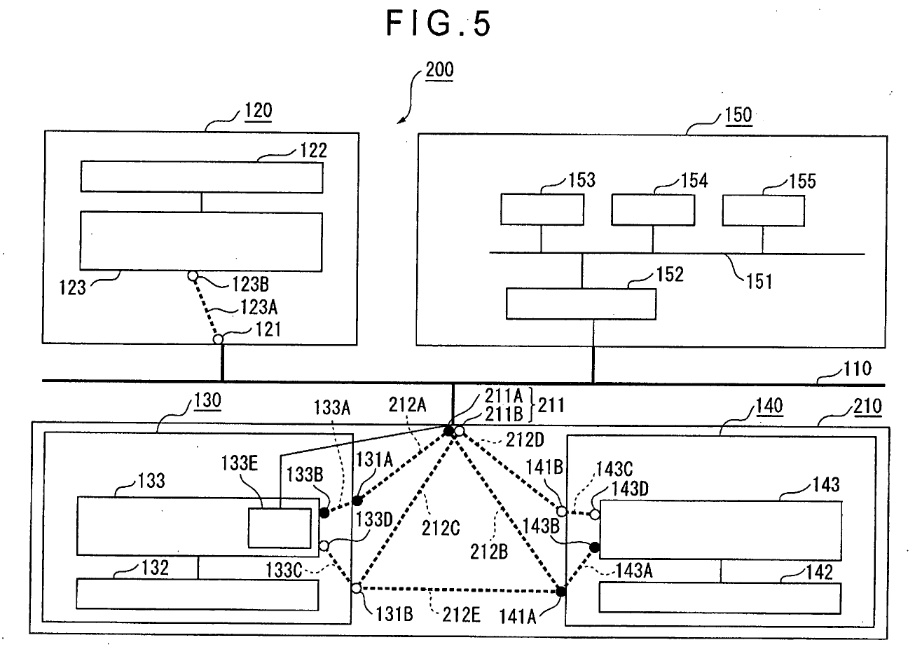

A second embodiment of the information recording device according to the present invention is described below with reference to the related drawings. This second embodiment has the configuration in which the HD device 130 and the contents recording device 140 in the first embodiment are integrally formed, namely, one recording device has a plurality of recording sections. It is to be understood that a plurality of recording sections includes not only the configuration in which different media such as the HD device 130 and the contents recording device 140 are combined, but also the configuration in which a plurality of media of the same kind such as the HD device 130 or the contents recording device 140 are employed, or the configuration in which a partition(s) is provided in a HD in the HD device 130 to divide a recording area thereof into two or more. FIG. 5 is a block diagram showing general configuration of the information processing device according to the second embodiment. It is to be noted that the same reference numerals are assigned to the same components as those in the first embodiment and are omitted herefrom.

(Configuration of Information Recording Device)

In FIG. 5, the reference numeral 200 indicates an information recording device, and this information recording device 200 includes a data bus 110, a contents sending device 120, a recording device 210, and a network controller 150. The recording device 210 records data fetched by the contents sending device 120 and then sent to the data bus 110. This recording device 210 includes a recording device plug 211, a HD device 130, and a contents recording device 140.

The recording device plug 211 is, for instance, a device plug as a logical concept, and is detachably connected to the data bus 110. The recording device plug 211 has a recording device input plug 211A and a recording device output plug 211B. The recording device input plug 211A receives data transmitted from the contents sending device 120 via the data bus 110. The recording device output plug 211B transmits data from the recording device 210 to the data bus 110.

The recording device input plug 211A is connected via a logical first recording device internal connection 212A of the recording device 210 to a first device input plug 131A of the HD device 130, and is also connected via a logical second recording device internal connection 212B of the recording device 210 to a second device input plug 141A of the contents recording device 140. With these connections, the HD device 130 and the contents recording device 140 fetch data received in the recording device input plug 211A.

The recording device output plug 211B is connected via a logical third recording device internal connection 212C of the recording device 210 to a first device output plug 131B of the HD device 130, and is also connected via a logical fourth recording device internal connection 212D of the recording device 210 to a second device output plug 141B of the contents recording device 140. With these connections, the HD device 130 and the contents recording device 140 transmit data to be recorded to the data bus 110.

A first device output plug 131B of the HD device 130 is connected via a logical fifth recording device internal connection 212E of the recording device 210 to a first device input plug 141A of the contents recording device 140. With these connections, the data recorded in the HD device 130 can be transmitted, namely transferred, to the contents recording device 140.

The network controller 150 is connected to the contents sending device 120 and recording device 210 each connected to the data bus 110, and controls operation of these contents sending device 120 and the recording device 210. Namely, a CPU 153 of the network controller 150 establishes the logical connection of the contents sending device 120 and the recording device 210 as well as the logical connection of the HD device 130 and the contents recording device 140 according to the necessity, to record and transfer the data according to the necessity.

(Operations of Information Recording Device)

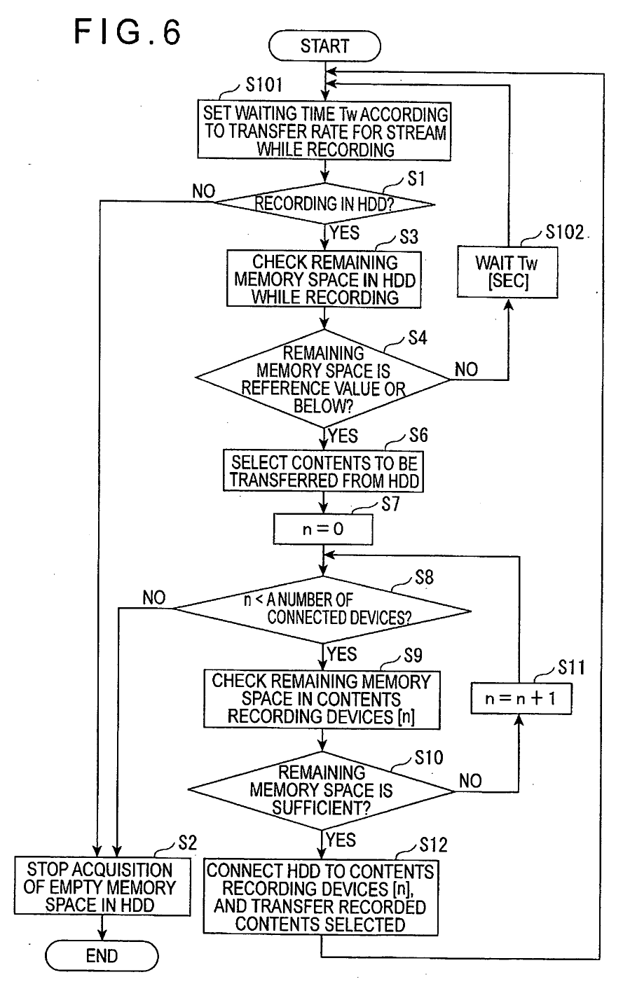

Operations of the information recording device 200 for picture recording are described below with reference to the related drawings. The operations for picture recording in this second embodiment are configured so that the liming of detection for the empty space in the HD device 130 in the first embodiment can be changed according to the necessity. FIG. 6 is a flowchart showing operations for recording picture data. It is to be noted that the same operations as those shown in the flowchart in FIG. 2 of the first embodiment are described omitting or simplifying herefrom.

At first, when a user turns on power, the CPU 153 in the network controller 150 recognizes the connected devices thereto and makes the memory 154 record the number of unit of the connected devices. When necessary data is selected with the input operations by the user for setting the start of picture recording, the CPU 153 controls the contents sending device 120, makes the data fetching section 122 fetch data, and also makes the contents sending section 123 process the data according to the necessity. The CPU 153 further establishes a sending device internal connection 123A, and also establishes the logical first recording device internal connection 212A in the recording device 210 and a logical first HDD internal connection 133B in the HD device 130, and makes the recording device input plug 211A connect to the logical HDD internal connection 133B via the first device input plug 131A of the HD device 130 so that the contents sending device 120 and the HD device 130 are connected with data being transferable therebetween. With this connection, data fetched and converted by the contents sending device 120 are sequentially transferred via the data bus 110 to the HD device 130, and are recorded in the HD by the HDD subunit 133.

The CPU 153 recognizes the state of a reducing empty space when the data is recorded in the HD device 130, such as a transfer rate of stream data of the fetched data to the HD device 130, and sets a waiting time Tw based on the recognized transfer rate (step S101). More specifically, the CPU 153 can recognize the state described above by reading out information concerning the device output plug 121 of the contents sending device 120, for instance, OPCR (Output Plug Control Register) in the International Standard IEC61883-1 via the data bus 110. This set waiting time Tw is stored in the memory 154 according to the necessity. It is to be understood that the recognition of the state of a reducing empty space is not limited to that through the transfer rate, and a forward rate which is a quantity of fetched data per unit of time in the data fetching section 122 may be used, or the reducing state may be recognized by checking an actual empty space based on the information concerning the internal state and comparing it to the empty space previously detected.

The CPU 153 then determines whether the data recording is now on or not in step S1, and, when the data recording is on, an empty space of the HD device 130 is checked in step S3. When the CPU 153 recognizes that the empty space of the HD device 130 is sufficient in step S4, after the waiting time Tw set in step S101 has passed by (step S102), the CPU 153 executes processing to continue the recording for picture data, by returning to the step S101. In the meantime, in step S4, when the CPU 153 determines that an empty space of the HD device 130 is a prespecified value or below, as in the first embodiment, the CPU 153 executes processing of step S6 and thereafter, and then executes processing to ensure an empty space of the HD device 130 by transferring other data having been recorded in the HD device 130 to the contents recording device 140.

More specifically, the CPU 153 establishes the logical fifth recording device internal connection 212E of the recording device 210, a logical second HDD internal connection 133C of the HD device 130, and the logical first recording internal connection 143A of the contents recording device 140, and makes the HD device 130 and the contents recording device 140 connected to each other with data being transferable therebetween. The CPU 153 further executes processing of transferring the data selected in step S6 and having been recorded in the HD in the HDD subunit 133 via the fifth recording device internal connection 212E, the second HDD internal connection 133C, and the first recording internal connection 143A to the contents subunit 143, and of making a recording medium recorded the same therein.

When a recording for picture data is finished and the recorded data is to be outputted, namely, to be reproduced with an output section, the CPU 153 fetches information concerning the internal state each from the HD device 130 and the contents recording device 140, and recognizes a device(s) in which data to be reproduced is recorded. The CPU 153 then establishes an internal connection in the device recorded therein the data to be reproduced, namely, when data recorded in the HD device 130 is to be reproduced, a third recording device internal connection 212C, and, when data recorded in the contents recording device 140 is to be reproduced, a fourth recording device internal connection 212D, to output the recorded data to the data bus 110 and to execute processing of transmitting the same to the output section for reproduction according to the necessity.

(Advantages in Second Embodiment)

As described above, in addition to having the similar action and effect to that of the first embodiment, the second embodiment discussed above has a configuration in which a waiting time Tw for returning to step S101 is set in order to detect once again the empty space of the HD device 130 in step S4, based on the state of a reducing empty space in the HD device 130, for instance, a transfer rate of stream data of the fetched data to the HD device 130. With this feature, even when a fluctuation rate of the remaining empty space is changed due to the corresponding fluctuation of the amount of data per unit of time recorded with the transfer rate, timing of detection for the empty space is changed accordingly, which can prevent a failure in picture recording because of running out of the empty space before the coming detection, further ensuring the data recording according to the state of recording.

In addition, the second embodiment has a configuration in which data is transferred within a single recording device 210, which allows the data to be transferred more rapidly compared to the case where the data is transferred via the data bus 110, easily enabling an improved efficiency of processing.

[Third Embodiment]

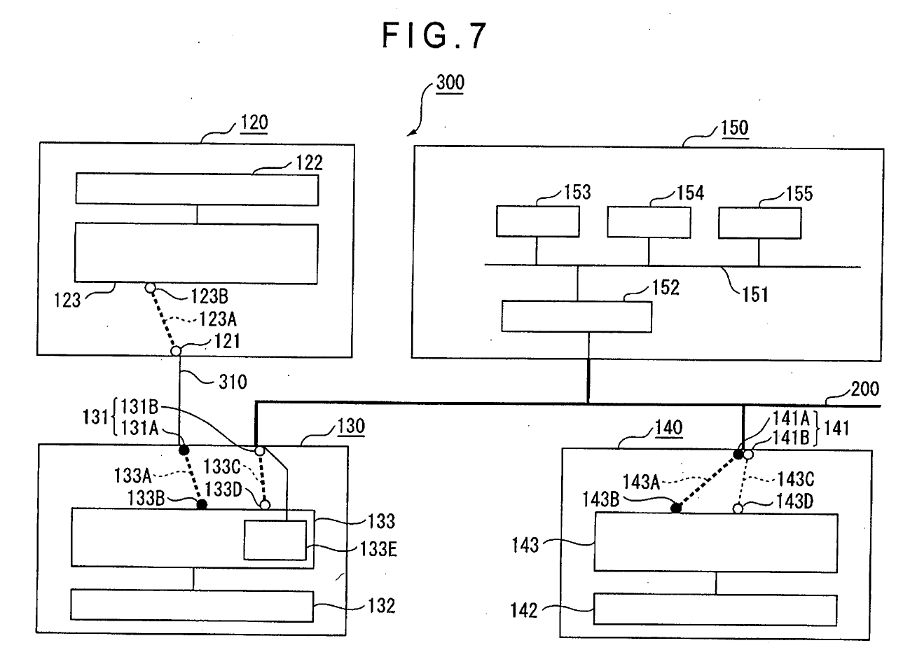

A third embodiment of the information recording device according to the present invention is described below with reference to the related drawings. The third embodiment has a configuration in which the contents sending device 120 in the first and second embodiments described above is separate from the main body, and data is transmitted via a connection with a unique connecting conformation to the HD device 130 and is recorded therein. FIG. 7 is a block diagram showing general configuration of the information processing device in the third embodiment. It is to be noted that the same reference numerals are assigned herein for description to the same configuration as that in the first and second embodiments.

In FIG. 7, the reference numeral 300 indicates an information recording device, and to this information recording device 300 is detachably connected a contents sending device 120 for fetching data via, for instance, a local connection 310. The information recording device 300 includes a data bus 110, a HD device 130, a contents recording device 140, and a network controller 150.

The local connection 310 connects a device output plug 121 of the contents sending device 120 and a first device input plug 131A of the HD device 130 so that data can be transacted therebetween. To this local connection 310 can be applied not only IEEE1394 but also any interface which transmit data as analogue or any other digital signals. For the local connection 310, either a fixed line using a cable or radio transmission using a radio medium may be available. In this third embodiment, the first device input plug 131A of the HD device 130 corresponds to the data fetching section according to the present invention.

The network controller 150 is further connected to the HD device 130 and the contents recording device 140 connected to the data bus 110, and controls operations of these HD device 130 and contents recording device 140. Namely, the CPU 153 of the network controller 150 establishes a logical internal connection each from the HD device 130 and the contents recording device 140 according to the necessity, and has the HD device 130 and the contents recording device 140 output for data recording, transferring, and reproducing according to the necessity. In addition, the contents sending device 120 as a separate body, based on, for instance, the operation contents set according to the necessity with input operations conducted in an input section not shown provided in this contents sending device 120, fetches data or establishes an internal connection according to the necessity, and transmits the data via the local connection 310 to the HD device 130.

By setting with input operations indicating the start of recording for picture data according to the necessity, as in the case with the operations in the first embodiment or the second embodiment, the information recording device 300 in the third embodiment shown in FIG. 7 establishes an internal connection in the HD device 130 according to the necessity and has the HD device 130 recorded therein the data fetched, and then, when the information recording device 300 recognizes that the empty space detected thereby in the HD device 130 drops to a prespecified value or below, the information recording device 300 establishes necessary internal connections, transfers via the data bus 110 other data having been recorded in the HDD main body 132 to the contents recording device 140, and executes processing for ensuring the empty space of the HD device 130. As described above, the third embodiment shown in FIG. 7 also has the action and effect similar to that in the first and the second embodiments.

In the third embodiment shown in FIG. 7, the configuration is allowable in which the network controller 150 and the contents sending device 120 are connected so that various information can be transacted therebetween, and the CPU 153 controls operations of the contents sending device 120. With this configuration, without executing input operations for operating the contents sending device 120, controls thereof can be provided by the CPU 153, which can improve management of the information recording device 300.

Another configuration is allowable in which the contents sending device 120 is integrally provided within the network controller 150, and the data fetched and processed thereby is transmitted to the data bus 110.

[Fourth Embodiment]

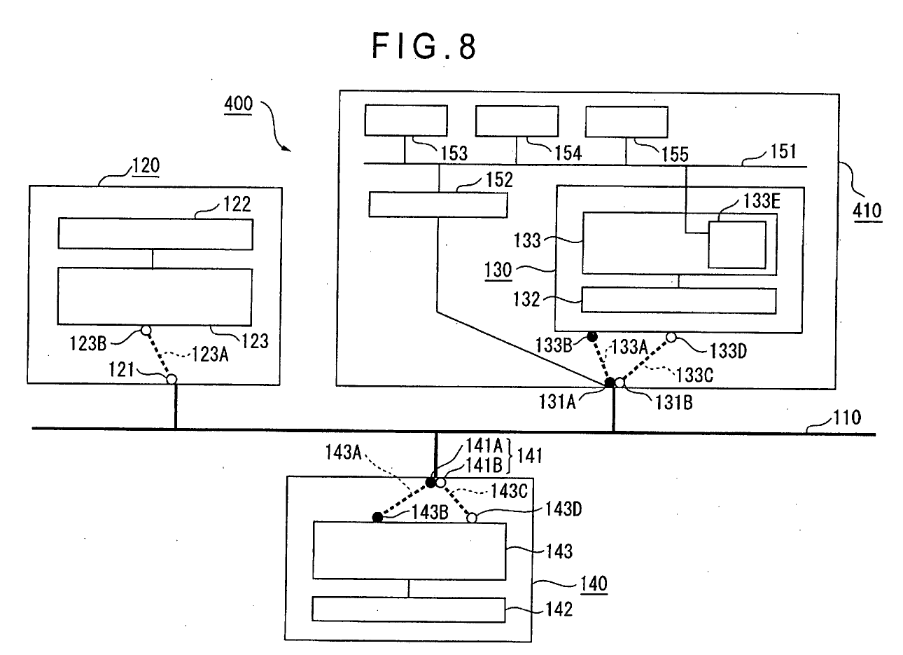

A fourth embodiment of the information recording device according to the present invention is described below with reference to the related drawings. This fourth embodiment is based on the configuration in which the HD device 130 is integrated with the network controller 150 in the first embodiment. Configuration in which data to be recorded and those to be transferred are transacted via the data bus 110 is described in relation to this fourth embodiment, but other configurations are allowable in which data recording and data transfer are executed through the internal bus 151 and the interface 152 and via the data bus 110, or in which information concerning the internal state is fetched via the internal bus 151. FIG. 8 is a block diagram showing general configuration of an information recording device according to the fourth embodiment. The same reference numerals are assigned to the same components and members as those in the first to third embodiments.

In FIG. 8, the reference numeral 400 indicates an information recording device, and this information recording device 400 includes a data bus 110, a contents sending device 120, a contents recording device 140, and a network controller 410.

The network controller 410 includes an internal bus 151, an interface 152, a CPU 153, a memory 154, an input section 155, and a HD device 130. The HD device 130 is connected to the internal bus 151, and the operations are controlled by the CPU 153, and further a first device plug 131 of the HD device 130 is connected to the data bus 110 so that data transaction can be executed. For convenience in description, a logical first HDD internal connection 133A and a logical second HDD internal connection 133C, a HD input plug 133B and a HD output plug 133I) of a HDD subunit 133 are shown outside the frame indicating the HD device 130 in FIG. 8, but the configuration is the same as that in the first embodiment.

The network controller 410 is connected to the contents sending device 120 and the contents recording device 140 connected to the data bus 110 respectively, and controls operations of the contents sending device 120 and the contents recording device 140. Namely the CPU 153 of the network controller 410 establishes the logical internal connection between the contents sending device 120 and the contents recording device 140 via the data bus 110 and the logical first HDD internal connection 133A and the logical second HDD internal connection 133C via the internal bus 151 according to the necessity, and executes operations for transmitting, recording, transferring, and replaying the data according to the necessity.

In the information recording device 400 according to the fourth embodiment, in response to an input operation for starting image data recording according to the necessity, like the operations in the first embodiment or in the second embodiment, the data fetched by establishing the internal connection is recorded in the HD device 130, and when it is recognized that an free space in the HD device 130 detected from time to time has dropped to a prespecified value or below, other data having been recorded in the HDD main body 132 is transferred via the data bus 110 to the contents recording device 140 by establishing the internal connection according to the necessity so that a required free space can be secured. As described above, also in the fourth embodiment, there are provided the same actions and advantages as those provided in the first to third embodiments. In the fourth embodiment, the HD device 130 is integrated with the network controller 150, so that the HDD subunit 133 can easily be controlled by the CPU 153 at a higher speed, which allows for improvement in the processing efficiency.

The fourth embodiment shown in FIG. 8 is described above assuming the configuration in which the first device plug 131 of the HD device 130 is connected to the data bus 110 and the data is recorded and transferred via the data bus 110, but the configuration is allowable in which the HD device 130 is not directly connected to the data bus 110 and data is recorded and transferred via, for instance, the internal bus 151 and the interface 152. Further also the internal state detecting section 133E is described assuming the configuration in which the CPU 153 is connected to the internal bus 151 so that the CPU 153 can fetch information concerning the internal state via the internal bus 151, but also the configuration is allowable in which the CPU 153 is not connected to the internal bus 151 and is connected to the data bus 110. It is to be noted that, with the configuration in which information concerning the internal state is fetched via the internal bus 151, information can be fetched at a high speed, which allows for improvement in the processing efficiency.

[Fifth Embodiment]

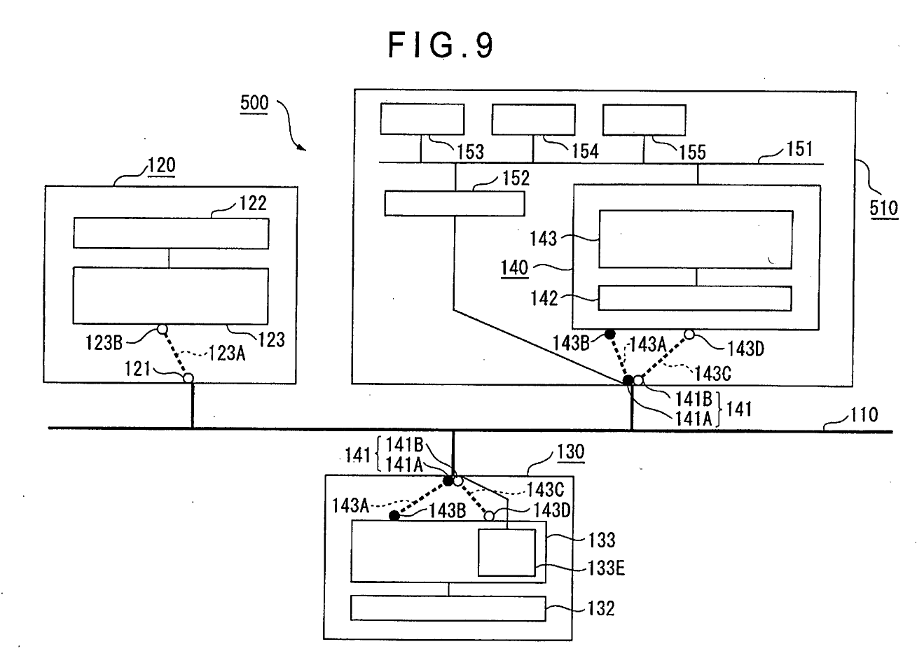

Next a fifth embodiment of the information recording device according to the present invention is described below with reference to the related drawings. The fifth embodiment is based on the configuration in which the contents recording device 140 is integrated with the network controller 150 in the first embodiment, namely based on the configuration in which the contents recording device 140 is integrated therein in place of the HD device 130 in the fourth embodiment. In this fifth embodiment, the configuration in which data transferred via the data bus 110 is fetched by the contents recording device 140 is described, but also the configuration is allowable in which data transferred, for instance, via the internal bus 151 and the interface 152 is fetched via the data bus 110. FIG. 9 is a block diagram showing general configuration of the information recording device in the fifth embodiment. It is to be noted that the same reference numerals are assigned to the same components as those in the first to fourth embodiments in the following description.

In FIG. 9, the reference numeral 500 indicates an information recording device, and this information recording device 500 includes a data bus 110, a contents sending device 120, a HD device 130, and a network controller 510.

The network controller 510 includes an internal bus 151, an interface 152, a CPU 153, a memory 154, an input section 155, and a contents recording device 140. The contents recording device 140 is connected to the internal bus 151 and the operations are controlled by the CPU 153, and the second device plug 141 of the contents recording device 140 is connected to the data bus 110 so that the data can be sent therefrom or received thereby. In FIG. 9, the logical first recording internal connection 143A and the logical second recording internal connection 143C, the recording input plug 143B and the recording output plug 143D of the contents subunit 143 are shown outside the frame for the contents recording device 140 for convenience in description, but the configuration is the same as that in the first embodiment described above.

The network controller 510 is connected to the contents sending device 120 and the HD device 130 each connected to the data bus 110, and controls operations of the contents sending device 120 and the HD device 130. Namely, the CPU 153 of the network controller 510 establishes the logical internal connections of the contents sending device 120 and the HD device 130 via the data bus 110, and also establishes the logical first recording internal connection 143A and the logical second recording internal connection 143C of the contents recording device 140 via the internal bus 151 according to the necessity, and makes these system components execute output operations for transmitting, recording, transferring, and replaying the data according to the necessity.

In the information recording device 500 in the fifth embodiment, in response to an input operation for starting picture recoding according to the necessity, like in the operations in the first embodiment or in the second embodiment, the internal connections are established according to the necessity to have the fetched data recorded in the HD device 130, and when it is recognized that an free space in the HD device 130 detected from time to time has dropped to a prespecified value or below, the internal connections are established according to the necessity to have other data having been recording in the HDD main body 132 transferred to the contents recording device 140 via the data bus 110 for securing an free space. As described above, also in the fifth embodiment shown in FIG. 9, there are provided the actions and advantages like those in the first to fourth embodiments. Also the fifth embodiment is based on the configuration in which the contents recording device 140 is incorporated in the network controller 150 in the integrated state, and therefore the CPU 153 can easily control the contents subunit 143 at a higher speed with the processing efficiency improved.

The fifth embodiment shown in FIG. 9 is described above assuming the configuration in which the second device plug 141 of the contents recording device 140 is connected to the data bus 110 for recording and transferring data via the data bus 110, but as described above, also the configuration is allowable, for instance, in which the contents recording device 140 is not directly connected to the data bus 110 and the data transferred via the internal bus 151 and the interface 152 is fetched or outputted for replaying.

[Sixth Embodiment]

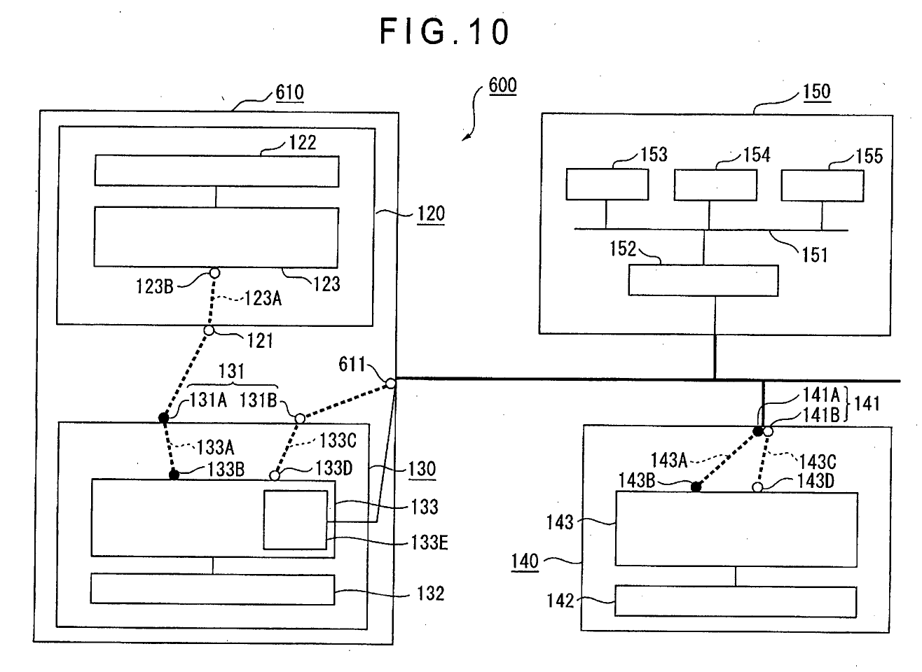

Next a sixth embodiment of the information recording device according to the present invention is described with reference to the related drawings. The sixth embodiment is based on the configuration in which the contents sending device 120 and the HD device 130 in the first embodiment are integrated with each other. FIG. 10 is a block diagram showing general configuration of the information recording device according to the sixth embodiment. It is to be noted that the same reference numerals are assigned to the same components as those in the first to fifth embodiments and detailed descriptions thereof are omitted herefrom.

In FIG. 10, the reference numeral 600 indicates an information recording device, and this information recording device 600 includes a data bas 110, a data fetching/recording device 610, a contents recording device 140, and a network controller 150. This data fetching/recording device 610 fetches data to be recorded and records the data therein. This data fetching/recording device 610 includes a fetching/recording device plug 611, a contents sending device 120, and a HD device 130.

The fetching/recording device plug 611 is, for instance, a device plug which is a logical concept, and is detachably connected to the data bus 110. This fetching/recording device plug 611 sends data from the data fetching/recording device 610 to the data bus 110. The fetching/recording device plug 611 is connected to a first device output plug 131B of the HD device 130 via a logical first internal connection 612A of the data fetching/recording device 610.

A first device input plug 131A of the HD device 130 is connected to the device output plug 121 of the contents sending device 120 via a logical second internal connection 612B of the data fetching/recording device 610. With this connection, the data fetched by the contents sending device 120 and transmitted from the contents sending section 123 can directly be fetched by the HD device 130.

The network controller 150 is connected to the data fetching/recording device 610 and the contents recording device 140 each connected to the data bus 110, and controls operations of the data fetching/recording device 610 and the contents recording device 140. Namely, the CPU 153 of the network controller 150 establishes the logical internal connections of the data fetching/recording device 610 and the contents recording device 140 and the logical internal connections of the contents sending device 120 and the HD device 130 according to the necessity, and executes the output operations for transmitting, recording, transferring, and replaying the data according to the necessity.

In the information recording device 600 in the sixth embodiment shown in FIG. 10, in response to an input operation for starting picture recording according to the necessity, like in the operations in the first and second embodiments, data fetched by establishing the internal connections according to the necessity is recorded in the HD device 130, and when it is recognized that an free space in the HD device 130 detected from time to time has dropped to a prespecified value or below, other data already having been recorded in the HDD main body 132 is transferred to the contents recording device 140 via the data bus 110 for securing a required free space by establishing the internal connections. As described above, also in the sixth embodiments shown in FIG. 10, there are provided the same actions and advantages as those provided in the first to fifth embodiments.

Further the data fetched in one data fetching/recording device 610 is transferred and recorded, so that data transfer can be executed at a higher speed as compared to the case where data is transferred via the data bus 110, and therefore the processing efficiency can easily be improved.

[Other Embodiments]

The present invention is not limited to the embodiments described above, and variants in the range in which the objects of the present invention can be achieved as described below are encompassed within a scope of the present invention.

Namely, the descriptions above assume use of the HD device 130 as a first recording section, but the present invention is not limited to the configuration in which data is recorded in a HD, and any configuration may be employed on the condition that data can be recorded and transferred to any recording medium. Although the above descriptions assume use of the first device plug 131 of a device plug which is a pair of logical concepts corresponding to one input and one output, also the configuration allowing concurrent processing of a plurality of contents streams is allowable in which, for instance, two contents streams are concurrently recorded, or three contents streams are concurrently replayed. Similarly, any configuration of the contents recording device 140 may be employed on the condition that data can be recorded in any recording medium and the recorded data can be replayed therefrom. The first and second recording sections may have any configuration so long as a recording medium can be loaded thereon and off therefrom, or so long as the recording sections have a recording medium like the HD device 130 respectively. Further in the descriptions above, the contents recording device 140 can output data to be replayed, but the configuration is allowable in which, for instance, the second recording internal connection is not provided, the recording medium is detached when the recorded data is to be replayed, and the data is replayed with another replay device, or in which the operation for fetching data to be transferred and operation for recording and replaying the data can concurrently be executed.

In the description, the HD device 130 has the configuration in which data can be recorded and transferred concurrently, but the configuration is allowable in which the operating mode for recording data and that for transferring data are switched according to the necessity. As the configuration in which the operating mode for recording data and that for transferring data are switched according to the necessity, there can be enlisted the configuration in which data transfer is stopped when data is recorded and data fetching is stopped when data is transferred, or in which a storage section for temporally storing data therein like a buffer is provided.

Further the descriptions above assume the configuration in which the operation for recording data is stopped when an free space in the contents recording device 140 is less than a prespecified value, but the configuration is allowable in which data is recorded in the HDD device 130 up to the limit, in which data is recorded in a HD in the compressed state, in which data having been recorded in the contents recording device 140 up to a limit of the free space therein is compressed and transferred, or in which, when data is to be recorded, a portion of the data is deleted, or a portion of the data little affecting the operations for replaying the remaining data even if the portion is transferred or deleted is deleted and then the remaining portion of the data is recorded or transferred.

Further the configuration is allowable in which the contents sending device 120, the HD device 130, and the contents recording device 140 are integrated with each other and is connected to the data bus 110 in the integrated state, and any combination of the contents sending device 120, the HD device 130, and the contents recording device 140 may be employed.

Further the configuration is allowable in which the contents recording device 140 is not connected to the data bus 110 and is connected in a specified connection state according to the necessity, and any combination of the contents sending device 120, HD device 130, and the contents recording device 140 each to be connected to the data bus 110 may be employed, and all of the components may be connected to the data bus 110 each in a specific connection state respectively. In this configuration, the network controller plays the role of the information recording device as a computing section according to the present invention.

Further, a computer as a computing section may be used as the information processing device, or the present invention is applicable also to a program for making a computer execute the operations as described above and to a recording medium with this program recorded therein. The computer as a computing section is not limited to a personal computer, and the configuration in which a plurality of computers are connected in the network-like state, and further a chip such as a microcomputer or a circuit board with a plurality of electronic parts mounted thereon is also encompassed within a scope of the present invention.

In the descriptions above of the second embodiment in which the timing for checking an free space in the HD device 130 in response to decrease thereof is changed according to the necessity, the configuration is assumed in which data is transferred during the operation for recording the data when an free space in the HD device 130 has dropped to a prespecified value or below, but the configuration is allowable in which the operation for recording data is once stopped when the data is to be transferred, or in which data recording and data transfer are not executed concurrently.

The electronic network for recording fetched data or that for transferring the data is not limited to the data bus 110 which is an electronic network allowing passage of data based on the IEEE 1394 standard, and data to be recorded and transferred may be transmitted and received through any specific connection such as that, for instance, described above and shown in FIG. 7.

The specific structures and procedures for practically carrying out the present invention may be changed and modified according to the necessity within a range in which the objects of the present invention can be achieved.

[Advantages in Embodiments]

In the embodiments as described above, under the controls by the CPU 153 of the network controller 150, the data fetched by the data fetching section 122 of the contents sending device 120 is transmitted to the HD device 130 and is recorded in a HD of the HDD main body 132, and concurrently whether an free space in the HD of the HDD main body 132 detected by the internal state detecting section 133E of the HDD subunit 133 has dropped to a prespecified value or below, or not is determined during the operation for recording the data. When it is determined that the free space has dropped to the prespecified value or below, other data having been recorded in the HDD main body 132 is transferred to the contents recording device 140 to continue the data recording operation.

Because of the configuration, even in a case where an free space previously acquired becomes short and the operation for picture recording is disabled, for instance when a signal type is changed to that requiring a higher data rate during the operation for picture recording as experienced in the configuration where an free space is previously acquired based on the data volume to be recorded, in the embodiments described above, an free space is secured by transferring the data having been recorded according to the necessity in response to a remaining free space changing according to a situation of data recording, so that data can be recorded without fail in response to a situation of data recording.

In addition, the waiting time Tw for again detecting an free space in the HD device 130 is set according to a transfer rate of a fetched data stream to the HD device 130. Because of the configuration, even if a data volume recorded within a unit period of time changes according to fluctuations of a transfer rate and a changing rate of the remaining free space fluctuates, the timing for detecting the free space is changed according to the actual situation, and such as a trouble as that, for instance, an free space becomes short before the next point of time for detecting an free space and the operation for picture recording is disabled can be prevented, and picture recording can be executed more accurately and without fail according to a situation of data recording.

1. An information recording device comprising:
a data fetching section for fetching data;
a first recording section capable of recording the fetched data therein;
an internal state detecting section for detecting, during the operation for recording the data in the first recording section, an free space for recording the data;
a second recording section capable of recording therein data having been recorded in the first recording section; and
a control section for transferring the data having been recorded in the first recording section to the second recording section for recording the data therein when it is recognized that the detected free space is a prespecified value or below.

2. The information recording device according to claim 1,
wherein a plurality of the second recording sections are provided, and
wherein the control section makes the data having been recorded in the first recording section transferred to and recorded in any one of the plurality of second recording sections.

3. The information recording device according to claim 1, further comprising:
a second internal state detecting section for detecting an free space for recording therein the data in the second recording section,
wherein when the control section recognizes that the free space in the first recording section detected by the internal state detecting section is the prespecified value or below, the control section makes the data having been recorded in the first recording section transferred to and recorded in the second recording section by recognizing that an free space in the second recording section detected by the second internal state detecting section is a prespecified value or above.

4. The information recording device according to claim 3, wherein when the control section recognizes that the free space in the second recording section detected by the second internal state detecting section is less than the prespecified value, the control section stops at least one of the operation for fetching data by the data fetching section and the operation for recording data in the first recording section.

5. The information recording device according to claim 1, wherein the control section recognizes a decrease state of the free space in the first recording section, and sets a timing for detecting the free space in the first recording section with the internal state detecting section based on the recognized decrease state of the free space.

6. The information recording device according to claim 5, wherein the control section recognizes the decrease state of the free space in the first recording section based on a volume of data fetched within a prespecified period of time when fetching the data with the data fetching section.

7. The information recording device according to claim 5, wherein the control section recognizes the decrease state of the free space in the first recording section based on a transfer rate of the data fetched by the data fetching section to the first recording section.

8. The information recording device according to claim 5, wherein the control section set a time interval between points of time for detecting the free space in the first recording section according to a rate of decrease of the free space.

9. The information recording device according to claim 1, wherein the control section makes the data fetched by the data fetching section passed through an electronic network allowing passage of the data based on the IEEE 1394 standard therethrough, as at least either one of the operation for transmitting the data to the first recording section or the operation for transferring the data from the first recording section to the second recording section.

10. The information recording device according to claim 1, wherein the first recording section can record and transfer the data concurrently.

11. An information recording device comprising:
a data fetching section for fetching data;
a plurality of recording sections capable of recording the fetched data therein;
an internal state detecting section for detecting an free space for recording therein the data in the recording section; and
a control section for making the fetched data recorded in any of the plurality of recording sections and transferring the data having been recorded in this recording section to other recording section when the control section recognized that an free space in the recording section for the data to be recorded therein is a prespecified value or below,
wherein the control section recognizes a decrease state of the free space in the recording section with the data recorded therein, and makes the internal state detecting section detect an free space in the recording section for the data to be recorded therein at a timing corresponding to the decrease state of the free space.

12. The information recording device according to claim 11, wherein the control section recognizes the free space in the recording section during the operation for recording the data.

13. An information recording device for recording input data in any of a plurality of recording sections comprising:
a control section for making the input data recorded in any of the plurality of recording sections and transferring the data having been recorded in the recording section to other recording section when an free space in the recording section with the data recorded therein is a prespecified value or below.

14. The information recording device according to claim 13, wherein the control section recognizes a connection state of the recording section when power is turned on, sequentially detects an free space detected when the power is turned on in each of other recording sections other than the recording section with the data having been recorded therein when the control section recognizes that an free space in the recording section with the data having been recorded therein is a prespecified value or below, and transfers the data having been recorded in the recording section with the data having been recorded therein to the other recording section recognized in the detecting step as having an free space equal to the prespecified value or above.

15. The information recording device according to claim 11, wherein the control section records the data in the recording section and the transfers the data having been recorded in the recording section to the other recording section concurrently.

16. The information recording device according to claim 13, wherein the control section records the data in the recording section and the transfers the data having been recorded in the recording section to the other recording section concurrently.

17. An information recording method for recording fetched data in any of a plurality of recording sections comprising the steps of:
recording the fetched data in any of the plurality of recording sections and also detecting an free space allowing for storage of data therein in the recording section with the data having been recorded therein; and
transferring, when it is recognized that the detected free space is a prespecified value or below, the data having been recorded in the recording section with the data having been recorded therein to any recording section other than the recording section with the data having been recorded therein.

18. An information recording method for recording fetched data in any of a plurality of recording sections comprising the steps of:
recognizing a decrease state of an free space in the recording section for the fetched data to be recorded therein;
detecting an free space in the recording section for the data to be recorded therein at a timing corresponding to the decrease state of this free space; and
transferring the data having been recorded in the recording section for the data to be recorded therein to other recording section when it is recognized that the detected free space is a prespecified value or below.

19. An information recording method for recording input data in any of a plurality of recording sections comprising the steps of:
having the input data recorded in any of the plurality of recording sections; and
transferring the data having been recorded in the recording section to other recording section when it is recognized that an free space in the recording section with the data recorded therein is a prespecified value or below.

20. An information recording program executing an information recording method for recording fetched data in any of a plurality of recording sections by a computer, the method comprising the steps of:
recording the fetched data in any of the plurality of recording sections and also detecting an free space allowing for storage of data therein in the recording section with the data having been recorded therein; and
transferring, when it is recognized that the detected free space is a prespecified value or below, the data having been recorded in the recording section with the data having been recorded therein to any recording section other than the recording section with the data having been recorded therein.

21. An information recording program executing an information recording method for recording fetched data in any of a plurality of recording sections by a computer, the method comprising the steps of:
recognizing a decrease state of an free space in the recording section for the fetched data to be recorded therein;
detecting an free space in the recording section for the data to be recorded therein at a timing corresponding to the decrease state of this free space; and
transferring the data having been recorded in the recording section for the data to be recorded therein to other recording section when it is recognized that the detected free space is a prespecified value or below.

22. An information recording program executing an information recording method for recording input data in any of a plurality of recording sections by a computer, the method comprising the steps of:
having the input data recorded in any of the plurality of recording sections; and
transferring the data having been recorded in the recording section to other recording section when it is recognized that an free space in the recording section with the data recorded therein is a prespecified value or below.

23. A recording medium storing an information recording program in a manner readable by a computer,
wherein the program executes an information recording method for recording fetched data in any of a plurality of recording sections by a computer,
the method comprising the steps of:
recording the fetched data in any of the plurality of recording sections and also detecting an free space allowing for storage of data therein in the recording section with the data having been recorded therein; and
transferring, when it is recognized that the detected free space is a prespecified value or below, the data having been recorded in the recording section with the data having been recorded therein to any recording section other than the recording section with the data having been recorded therein.

24. A recording medium storing an information recording program in a manner readable by a computer,
wherein the program executes an information recording method for recording fetched data in any of a plurality of recording sections by a computer,
the method comprising the steps of:
recognizing a decrease state of an free space in the recording section for the fetched data to be recorded therein;
detecting an free space in the recording section for the data to be recorded therein at a timing corresponding to the decrease state of this free space; and
transferring the data having been recorded in the recording section for the data to be recorded therein to other recording section when it is recognized that the detected free space is a prespecified value or below.

25. A recording medium storing an information recording program in a manner readable by a computer,
wherein the program executes an information recording method for recording input data in any of a plurality of recording sections by a computer,
the method comprising the steps of:
having the input data recorded in any of the plurality of recording sections; and
transferring the data having been recorded in the recording section to other recording section when it is recognized that an free space in the recording section with the data recorded therein is a prespecified value or below.
